(19) United States
(12) Patent Application Publication
(10) Pub. No.: US 2015/0356699 A1
(43) Pub. Date: Dec. 10, 2015

(54) DYNAMIC SCHEDULING OF PARTICIPANTS INTO GROUPS

(71) Applicant: Promethean Limited, Blackburn (GB)

(72) Inventors: Steven C. Velozo, Seattle, WA (US); Alex H. Decker, Seattle, WA (US)

(21) Appl. No.: 14/297,743

(22) Filed: Jun. 6, 2014

(51) Int. Cl. G06Q 50/20; G06Q 10/00

(52) U.S. Cl. CPC G06Q 50/205; G06Q 10/00

(57) ABSTRACT

A dynamic scheduling system according to various embodiments is configured to optimize pairings of one or more students with one or more teachers, one or more classrooms, and one or more activities. In various embodiments, the system is configured to optimize the pairings based at least in part on one or more needs of the one or more students, as well as teacher, classroom, activity and resource availability. In particular embodiments, the system is configured to factor in a plurality of needs for each particular student while weighing the plurality of needs of each particular student against the needs of other students when optimizing the pairings.

### BACKGROUND

In today's school environment, students are scheduled into various classes throughout the day. In particular, a student may have math during first period, biology during second period, social studies during third period, lunch during fourth period, physical education during fifth period, an elective subject matter during six period and English during seventh period. The class schedule for any particular student does not vary from day to day regardless of whether the student needs more help with math than biology. Thus, each student's ability to learn any one subject matter faster than another is not taken into account in meeting the learning needs of each particular student.

Various embodiments of the present systems and methods recognize and address the foregoing considerations, and others, of prior art systems and methods.

### SUMMARY

In an embodiment, the invention is directed to a system for adaptively scheduling a plurality of students in a plurality of classrooms that comprises at least one processor, memory coupled to the at least one processor, and a display operatively coupled to the at least one processor. In various embodiments, the at least one processor is configured to receive information regarding each one of a plurality of students and the skills that each student needs to learn, as determined prior to a first particular time period. Skills that are needed to be learned may be based on any subject matter (e.g., math, science, social studies, English, language arts, etc.) and may be a subset of any one particular subject matter (e.g., for math the skill may be addition, subtraction, multiplication, etc.). The system may also be configured to receive information regarding a plurality of skills and the resources needed for each one of the plurality of skills. For example, for the skill of addition, the system may select from one or more activities for teaching addition where each activity (e.g., playing a dice game, making change, working in groups, etc.) requires different resources (e.g., dice, fake money, group stations, etc.) to complete the activity.

Furthermore, the system may also be configured to receive information regarding the available teachers during the particular period of time, and to receive information regarding the available classrooms during the particular period of time and the resources available in each one of the available classrooms. The system, based at least partially upon receiving the at least one or more of the foregoing, calculates assignments of students, teachers, and classrooms to best meet the learning needs of a majority of the students, and display the assignments for the particular period of time to the students and teachers prior to the start of the particular period of time.

### BRIEF DESCRIPTION OF THE DRAWINGS

A full and enabling disclosure of the present invention, including the best mode thereof directed to one of ordinary skill in the art, is set forth in this specification, which makes reference to the appended drawings, in which:

FIG. 1 a is block diagram of an exemplary system for dynamically scheduling one or more participants in accordance with an embodiment of the present system;

FIG. 2 is a block diagram of a computer that may be used, for example, as the scheduling server within the context of the system of FIG. 1; and

FIG. 3 comprises a flow diagram illustrating an exemplary presentation process performed by the system of FIG. 1.

### DETAILED DESCRIPTION

Reference will now be made in detail to presently preferred embodiments of the present system, one or more examples of which are illustrated in the accompanying drawings. Each example is provided by way of explanation of the invention, not limitation of the invention. In fact, it will be apparent to those skilled in the art that modifications and variations can be made to the present invention without departing from the scope or spirit thereof For instance, features illustrated or described as part of one embodiment may be used in another embodiment to yield a still further embodiment. Thus, the present invention covers such modifications and variations as come within the scope of the appended claims and their equivalents.

### Overview

A dynamic scheduling system, in various embodiments, is configured to assign each particular student of a plurality of students to a particular available classroom to perform a particular activity or lesson available in that particular available classroom that is supervised by a particular available instructor. In particular embodiments, the system is configured to receive information that comprises: (1) information associated with one or more available classrooms; (2) information associated with one or more available instructors; (3) information associated with one or more available resources; and (4) information associated with one or more needs of each of the plurality of students, where the one or more needs may include, for example, a need to improve in a particular academic area of a particular academic subject (e.g., reading, adding, subtracting, stoichiometry, etc.). In various embodiments, the system is configured to dynamically schedule each of the plurality of students into an available classroom with an available instructor for a first particular time period to perform a particular lesson or activity based at least in part on each student's needs. In various embodiments the system is configured to weigh a first student's needs against a second student's needs in order to complete the dynamic scheduling. For example, where more than a maximum number of students have a need to complete a particular lesson that requires placement in a particular classroom, the system will determine which students have the greatest need for that particular lesson when scheduling the students and also whether a student has another need that can be satisfied by another lesson being offered at the same time. In particular embodiments, the system is configured to optimize the pairing of students, classrooms, teachers, and activities/lessons in order to provide the substantially greatest benefit to the plurality of students as a whole rather than, for example, any particular student individually.

### Exemplary Technical Platforms

As will be appreciated by one skilled in the relevant field, the present systems and methods may be, for example, embodied as a computer system, a method, or a computer program product. Accordingly, various embodiments may be entirely hardware or a combination of hardware and software. Furthermore, particular embodiments may take the form of a computer program product stored on a computer-readable storage medium having computer-readable instructions (e.g., software) embodied in the storage medium. Various embodiments may also take the form of web-implemented computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatuses (e.g., systems), and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, a special purpose computer, or other programmable data processing apparatus to produce a machine. As such, the instructions executed on the general purpose computer, special purpose computer, or other programmable data processing apparatus can direct a computer or other programmable data processing apparatus to function in a particular manner such that the instructions stored in the computer-readable memory produce an article that is configured for implementing the functions specified in the flowchart block or blocks.

The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including but not limited to: a local area network (LAN); a wide area network (WAN); a cellular network; or the connection may be made to an external computer (for example, through the Internet using an Internet Service Provider).

These computer program instructions may also be stored in a computer-readable memory that can direct a computer or other programmable data processing apparatus to function in a particular manner such that the instructions stored in the computer-readable memory produce an article that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that are executed on the computer or other programmable apparatus provide steps for implementing the functions specified in the flowchart block or blocks.

### Example System Architecture

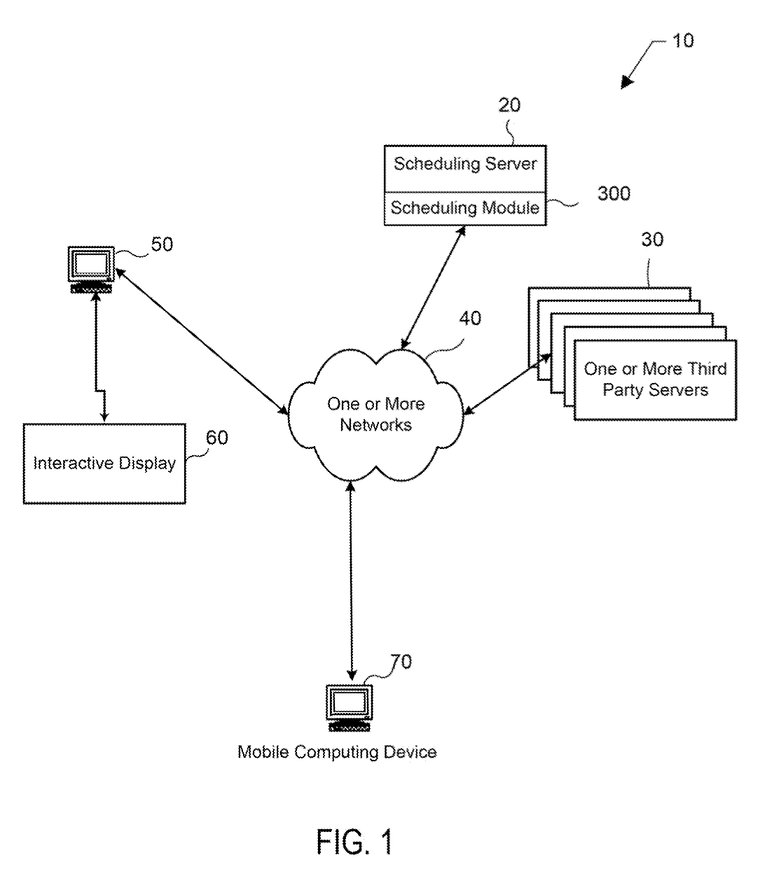

FIG. 1 is a block diagram of a dynamic scheduling system 10 according to a particular embodiment that is configured for assigning each particular student of a plurality of students to a particular available classroom to perform a particular activity or lesson available in that particular available classroom that is supervised by a particular available instructor. In particular embodiments, the system is configured to receive information that comprises: (1) information associated with one or more available classrooms; (2) information associated with one or more available instructors; (3) information associated with one or more available resources; and (4) information associated with one or more needs of each of the plurality of students, where the one or more needs may include, for example, a need to improve in a particular academic area of a particular academic subject (e.g., reading, adding, subtracting, stoichiometry, etc.). As may be understood from this figure, the dynamic scheduling system 10 includes a scheduling server 20, one or more third party servers 30, one or more networks 40, one or more remote computing devices 50 (which may be, for example, a desktop computer, a laptop computer, a mobile computing device, a smart TV, etc.), an interactive display 60 coupled to the one or more remote computing devices, and/or one or more mobile computing devices 70 (e.g., a tablet, a smart phone, a laptop, a wearable computing device, etc.). The scheduling server 20, one or more third party servers 30, one or more remote computing devices 50, interactive display 60, and one or more mobile computing devices 70 communicate with one another over the one or more networks 40. The scheduling server 20 and one or more third party servers 30 may be any suitable computer device (e.g., a desktop computer, a laptop computer, etc.). The scheduling server 20 comprises one or more modules (e.g., scheduling module 300).

The one or more networks 40 may include any of a variety of types of wired or wireless computer networks such as the Internet, a private intranet, a mesh network, a public switch telephone network (PSTN), or any other type of network (e.g., a network that uses Bluetooth or near field communications to facilitate communication between computers). The one or more networks 40 may be a local area network (LAN), a wide area network (WAN), a cellular network, and/or the connection may be made to an external computer (for example, through the Internet using an Internet Service Provider). In particular embodiments, the one or more networks 40, together with the scheduling server 20, facilitate communication between the one or more third party servers 30, one or more remote computing devices 50, interactive display 60, and/or one or more mobile computing devices 70, as described in more detail herein.

The one or more remote computing devices 50 are operatively connected to the interactive display 60 by a universal serial bus (USB). In other embodiments, one or more remote computing devices 50 may be operatively connected to the interactive display 60 by Wi-Fi, Bluetooth, or any suitable wireless protocol type connection. The interactive display 60 may be, for example, any suitable display device with input/output capabilities (e.g., a monitor, a smart TV, etc.). In a particular embodiment, the interactive display 60 is an interactive whiteboard that is touch and/or pen input enabled, such as those produced by Promethean World Plc. (Promethean, Ltd.). An example of an interactive whiteboard is described in U.S. Pat. No. 8,325,162 to Promethean Ltd., which is incorporated by reference herein in its entirety. It should be understood, in light of this disclosure, that the interactive display 60, in one or more embodiments, is an interactive display other than a whiteboard, such as a computer monitor, which may or may not be touch-enabled, a touch screen computer, an interactive table display, a projector with a screen having one or more input sensor (e.g., a light curtain), a television operatively connected to one or more motion sensing devices, etc.

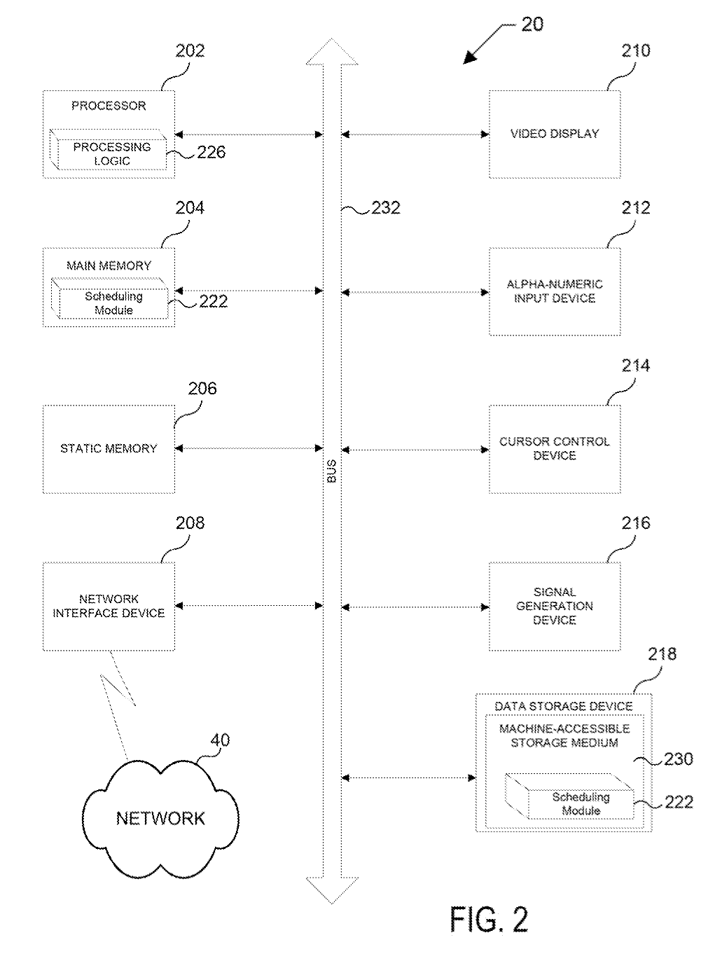

FIG. 2 provides a more detailed view of a computing device that may be used, for example, within the dynamic scheduling system 10 as a suitable scheduling server 20. However, it should be understood that similar computing devices may be used as one or more of the system's other computer components (e.g., the one or more third party servers 30, one or more remote computing devices 50, interactive display 60, and/or one or more mobile computing devices 70).

In particular embodiments, the scheduling server 20 may be connected (e.g., networked) to one or more other computers via a LAN, an intranet, an extranet, and/or the Internet (e.g., one or more networks 40). As noted above, the scheduling server 20 may operate in the capacity of a client computer in a client-server network environment, and/or as a peer computer in a peer-to-peer (or distributed) network environment. The scheduling server 20 may be a desktop personal computer (PC), a tablet PC, a set-top box (STB), a Personal Digital Assistant (PDA), a cellular telephone, a web appliance, smart TV, an interactive whiteboard, a server, a network router, a switch or bridge, or any other computer capable of executing a set of instructions (sequential or otherwise) that specify actions to be taken by that computer. Further, while only a single computer is illustrated, the term “computer” should also be understood to include any collection of computers that individually or jointly execute a set (or multiple sets) of instructions to perform any one or more of the methodologies discussed herein.

An exemplary scheduling server 20 includes a processor 202, a main memory 204 (e.g., read-only memory (ROM), flash memory, dynamic random access memory (DRAM) such as synchronous DRAM (SDRAM) or Rambus DRAM (RDRAM), etc.), a static memory 206 (e.g., flash memory, static random access memory (SRAM), etc.), and a data storage device 218, which communicate with each other via a bus 232. The scheduling server 20 may further include a network interface device 208, a video display unit 210 (e.g., a liquid crystal display (LCD) or a cathode ray tube (CRT)), an alphanumeric input device 212 (e.g., a keyboard), a cursor control device 214 (e.g., a mouse), and a signal generation device 216 (e.g., a speaker)).

The processor 202 represents one or more general-purpose processors such as a microprocessor, a central processing unit, or the like. More particularly, the processor 202 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processor 202 may also be one or more special-purpose processors such as an application specific integrated circuit (ASIC), a field programmable gate array (FPGA), a digital signal processor (DSP), network processor, or the like. The processor 202 may be configured to execute processing logic 226 for performing various operations and steps discussed herein.

The data storage device 218 may include a machine-accessible storage medium 230 (also known as a non-transitory computer-readable storage medium or a non-transitory computer-readable medium) on which is stored one or more sets of instructions (e.g., the scheduling module 300) embodying any one or more of the methodologies or functions described herein. The scheduling module 300 may also reside, completely or at least partially, within the main memory 204 and/or within the processor 202 during execution thereof by the scheduling server 20—the main memory 204 and the processor 202 also constituting computer-accessible storage media. The scheduling module 300 may further be transmitted or received over the network 40 via a network interface device 208. It should be understood that of the scheduling server 20 (or other system computers, or other computers outside the system). Operation of the scheduling module 300 is discussed in further detail below.

While the computing device-accessible storage medium 230 is shown in an exemplary embodiment to be a single medium, the term “computing device-accessible storage medium” should be understood to include a single medium or multiple media (e.g., a centralized or distributed database, and/or associated caches and servers) that store the one or more sets of instructions. The term “computing device-accessible storage medium” should also be understood to include any medium that is capable of storing, encoding or carrying a set of instructions for execution by the computing device and that cause the computing device to perform any one or more of the methodologies of the present invention. The term “computing device-accessible storage medium” should accordingly be understood to include, but not be limited to, solid-state memories, optical and magnetic media, etc.

### Exemplary Scheduling Method

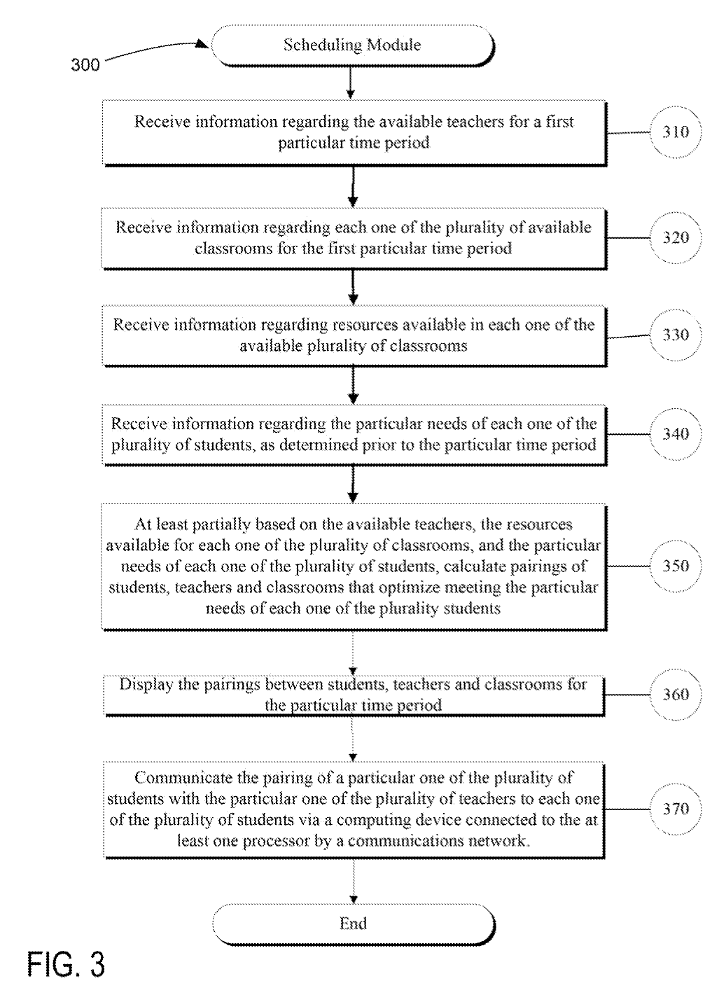

The system of FIG. 1 may be configured to perform the method steps of FIG. 3.

Moreover, the method described in FIG. 3 is an example of an embodiment of a present method for dynamically scheduling students and teachers in respective classrooms based on the needs of the student. It should be understood by reference to this disclosure that the method describes an exemplary embodiment of the method steps carried out by the present system, and that other exemplary embodiments may be created by adding other steps, by removing one or more of the method steps, or performing one or more of the method steps in an order other than the order in which they described in FIG. 3.

Referring to FIG. 3, when executing the Scheduling Module 300, the system begins, at

Step 310 by receiving information regarding available teachers for a first particular time period. In various embodiments, the available teachers may include any teachers at a particular school that are assigned (e.g., scheduled) to work during the first particular time period. In particular embodiments, the information regarding the available teachers may include, for each one of the available teachers any of the following information: (1) one or more subjects that the teacher is qualified to teach (e.g., math, science, social studies, English, one or more foreign languages, etc.); (2) a subspecialty within the one or more subjects in which the teacher may specialize (e.g., calculus or algebra in the case of math, American history in the case of social studies, etc.); (3) information associated with one or more special qualifications or certifications the teacher may have such as, for example, certification to work with special needs students, certification to work with English as a Second Language (ESL) students, etc.; (4) information associated with one or more age levels or grade levels the teacher is qualified to teach, is assigned to teach, or has a preference for teaching; (5) information associated with one or more particular lessons the teacher is capable of teaching; (6) information associated with one or more students the teacher has taught previously and information associated with how those one or more students have performed when taught by the teacher (e.g., based on the one or more student's performance on one or more graded assignments for the teacher, etc.); and/or (7) any other suitable information related to the available teachers.

In particular embodiments, the systems are configured to receive the information related to the available teachers from a database or other suitable source that includes a listing of one or more teachers and periods to which the one or more teachers are assigned to teach (e.g., a listing of which of a plurality of teachers are assigned to teach during the first particular time period and are therefore available teachers for the particular period).

Continuing at Step 320, the system receives information regarding each one of a plurality of available classrooms for the first particular time period. In various embodiments, the available classrooms for the first particular time period may include all classrooms in a particular school. In other embodiments, the available classrooms for the first particular time period may include all classrooms in a particular school that are not already assigned or known to be in use during the first particular time period. In particular embodiments, the available classrooms for the first particular time period may include all the available classrooms for a portion of a larger academic institution, such as, for example, all available classrooms associated with a particular college within a particular university, all available classrooms in a particular building of a particular school (e.g., a high school, middle school, elementary school, etc.), all available classrooms in a particular portion of a school (e.g., the middle school portion of a preparatory school that includes both a middle and high school), etc.

In various embodiments, the information regarding each one of the plurality of available classrooms may include, for example: (1) a capacity of each classroom (e.g., number of seats available); (2) an arrangement of each classroom (e.g., whether the classroom has individual student desks, lab stations for one or more students, one or more tables and how many students each of the one or more tables can accommodate, an auditorium arrangement, etc.); (3) resources available in each classroom (e.g., fixed resources) such as, for example, chalkboards, whiteboards, computers, particular software installed on computers, power outlets, gas lines (e.g., for Bunsen burners, etc.), or any other resource that may be available in a classroom (e.g., to aid in teaching or for use in particular lessons and activities); and/or (5) any other suitable information related to each classroom.

Next, at Step 330, the system receives information regarding one or more resources available in each one of the plurality of available classrooms. In various embodiments, the one or more resources include any of the one or more resources discussed immediately above. In other embodiments, the resources may include fixed resources, which may for example, be substantially permanently fixed within each one of the plurality of classrooms (e.g., a gas line, power outlet, blackboard mounted to the wall, etc.). In other embodiments, the one or more resources may include mobile resources which, although temporarily housed within a particular one of the plurality of available classrooms, may be moveable to a different one of the available classrooms. Mobile resources may include, for example, one or more board games (e.g., card games, dice, etc.), one or more textbooks, one or more instruments, one or more school supplies (e.g., notebooks, pencils, pens, markers, crayons, highlighters, rulers, calculators, etc.), or any other suitable resources which may, for example, be required for a particular teaching activity.

Continuing at Step 340, the system receives information regarding one or more particular needs for each one of a plurality of students, the one or more particular needs having been determined at a time prior to the first particular time period. In various embodiments, the one or more particular needs are one or more needs to improve in a particular subject and/or a particular topic within the particular subject. A particular student may, for example need to improve in a subject generally or may have a need to improve or learn a particular concept within that subject. Exemplary subjects and concepts within those subjects may include, for example: (1) addition, subtraction, multiplication, order of operations, algebra, graphing, etc., for math; (2) reading, spelling, vocabulary, analogies, literature, poetry, etc., for English; (3) American history, civil war history, government, tenants of major world religions, etc., for social studies; and/or (4) any other suitable subject or concept within a particular subject which may be taught in any particular school or other learning/teaching settings. In various embodiments, the system is configured to determine and/or receive one or more needs of a particular student based at least in part on: (1) the student's performance on a particular graded assignment in a particular subject or covering a particular topic; (2) one or more instructor reviews of the student's work; (3) an indication from the student that the student does not understand a particular subject/topic; (4) input received about the student from a system as described in either (a) U.S. patent application Ser. No. 14/297,513, filed on Jun. 5, 2014, by inventor Steven C. Velozo, et al., and entitled “SYSTEMS AND METHODS FOR TRACKING OBJECT ASSOCIATION OVER TIME,” which is hereby incorporated herein by reference in its entirety or (b) U.S. patent application Ser. No. 14/297,494, filed on Jun. 5, 2014, by inventor Steven C. Velozo, et al., and entitled “SYSTEMS AND METHODS FOR DETECTING, IDENTIFYING AND TRACKING OBJECTS AND EVENTS OVER TIME,” which is hereby incorporated herein by reference in its entirety, (5) results received for each student from standardized testing scores; or (6) any other suitable factor.

In other embodiments, the one or more particular needs of each student may include a preferred learning style of the student. For example, particular students may have a demonstrated, stated, or ascertained preference for hands on learning, rote learning, or any other learning style. In various embodiments, the system is configured to determine a student's preferred learning style based at least in part on the student's performance on one or more graded assignments following lessons geared toward one or more particular learning styles, based on a preference provided by each student, based on an observed preference by one or more instructors/teachers of the student, or in any other suitable manner.

In various embodiments, the system is configured to determine a hierarchy of needs for each particular student (e.g., prioritize the student's needs) based on any suitable factor. In particular embodiments, a particular student's needs may be based at least in part on subjects or topics for which the student has performed the most poorly. In other embodiments, the system is configured to determine a student's most pressing needs based on needs of the student that have yet to be fulfilled (e.g., a particular student may be poor in math and have a need there, but the student may also have yet to receive instruction in English where they also have a need).

In various embodiments, the system continues, at Step 350, by, at least partially based on the available teachers, the resources available for each one of the plurality of classrooms, and the one or more particular needs of each one of the plurality of students, calculating pairings of students, teachers, and classrooms that optimize meeting the particular needs of each one of the plurality of students. In various embodiments, the system may initially group particular students of the plurality of students that share the same one or more particular needs. In particular embodiments, the system may then determine available activities/lessons, for example, based on those lessons/activities that one or more of the available teachers are capable of leading. The system may then determine which of those available lessons/activities the one or more students have previously completed (e.g., so a particular student does not repeat an activity). The system then assigns each particular student an optimal activity, for example, based at least in part on the shared needs groupings, classroom availability and/or capacity, teacher availability, activities previously completed, and available resources that particular activities may require.

In various embodiments, a particular classroom hosting a particular activity may have insufficient capacity to accommodate all students having a need to complete that activity. In such embodiments, the system is configured to optimize student placement across all available classrooms, with all available teachers and resources in a manner that provides substantially the most benefit to the plurality of students as a whole, or to a particular number of the plurality of students, rather than any particular student individually.

In particular embodiments, the system is configured to use any suitable machine learning algorithm to optimize student pairing (e.g., via one or more suitable neural networks). In various embodiments, the system is configured to receive input concerning each student's performance in a paired activity (e.g., based on a quiz score, teacher review, etc.), which the system may store and utilize in future optimizations in creating a custom schedule for a later particular time period.

The system, at Step 360, displays the parings between students, teachers, and classrooms for the first particular time period. In particular embodiments, the system is configured to display the parings on the interactive display 60 described above, which may, for example, be positioned in a place of prominence within a school for which the system is implementing the present method. The system may, for example, display the pairings on the interactive display 60 in such a way that a student would be able to consult the interactive display 60 prior to the beginning of the first particular time period in order to ascertain the particular classroom with which the student was paired for the first particular time period. In embodiments in which the first particular time period is a first period during a day comprising one or more additional periods (e.g., as in the case of a school day divided into multiple periods), the system may be configured to display (e.g., on the interactive display 60) the pairings for each particular period during a time leading up to the particular period (e.g., between a period immediately before the particular period and the particular period) in order to direct students to the proper, paired classroom for the particular period.

Continuing at Step 370, the system communicates the pairing of a particular one of the plurality of students with the particular one of the plurality of teachers to each one of the plurality of students via a computing device connected to the at least one processer by a communication network. In various embodiments, the system is configured to communicate the pairings to the students, to the teachers, to one or more people associated with the students (e.g., a parent, guardian, etc.), or any other person who may desire to know of the pairings. In other embodiments, the system is configured to communicate the pairings to one or more people by including the pairings as part of a message (e.g., e-mail, text message, SMS, etc.) transmitted to a computing device associated with the one or more people. In various embodiments, the communication further comprises information associated with the paired classroom for the particular one of the plurality of students for the first particular time period.

Conclusion

Many modifications and other embodiments of the invention will come to mind to one skilled in the art to which this invention pertains having the benefit of the teachings presented in the foregoing descriptions and the associated drawings. In light of the above, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

What is claimed is:

1. A system for adaptively scheduling a plurality of students in a plurality of classrooms comprising:
a. at least one processor;
b. memory coupled to the at least one processor, and
c. a display operatively coupled to the at least one processor, wherein the at least one processor is configured to:
i. receive information regarding each one of a plurality of students and at least one skill that each student needs to learn, as determined prior to a first particular time period;
ii. receive information regarding a plurality of skills and resources needed for each one of the plurality of skills;
iii. receive information regarding teachers that are available during the first particular period of time;
iv. receive information regarding classrooms that are available during the first particular period of time and resources that are available in each one of the available classrooms;
v. at least partially based on the skills that each student needs to learn, the plurality of skills and resources needed for each one of the plurality of skills, the available classrooms and resources available in each one of the available classrooms, calculate assignments of students, teachers, and classrooms to meet the learning needs of a majority of the plurality of students; and
vi. display, to the teachers and students, the assignments for the particular period of time prior to the start of the particular period of time.

2. The system of claim 1, wherein the information regarding the plurality of skills and resources needed for each one of the plurality of skills further comprises:
a. information regarding a plurality of lessons where each of the plurality of lessons comprises one or more activities; and
b. information regarding one or more resources that are required for each one of the plurality of students to complete the one or more activities.

3. The system of claim 1, wherein calculating optimized assignments of students, teachers, and classrooms further comprises:
a. grouping students based on the one or more skills that each student needs to learn;
b. determining which activities that each particular student has previously completed; and
c. assigning an optimal activity to each particular student at least partially based on the student groupings, the information regarding the available classrooms, the information regarding the available teachers and each previously completed activity for each particular student.

4. The system of claim 2, wherein the one or more resources are chosen from a group consisting of:
a. dice;
b. play money;
c. interactive white board;
d. computers;
e. collaborative work stations;
f. game boards;
g. books; and
h. art supplies.

5. The system of claim 2, wherein the plurality of lessons are chosen from a group consisting of:
a. math lessons;
b. reading lessons;
c. language arts lessons;
d. social studies lessons; and
e. science lessons.

6. A system for adaptively scheduling a plurality of students in classrooms based on the particular needs of the students, the system comprising:
a. at least one processor;
b. memory coupled to the at least one processor, and
c. a display operatively coupled to the at least one processor,
wherein the at least one processor is configured to:
i. receive information regarding the available teachers for a first particular time period;
ii. receive information regarding each available classroom for the first particular time period;
iii. receive information regarding resources available in each one of the available plurality of classrooms;
iv. receive information regarding the particular needs of each one of the plurality of students, as determined prior to the first particular time period;
v. at least partially based on the available teachers, the resources available for each one of the plurality of classrooms, and the particular needs of each one of the plurality of students, calculate pairings, of students, teachers and classrooms that optimize meeting the particular needs of each one of the plurality students; and
vi. display the pairings between students, teachers and classrooms for the first particular time period.

7. The system of claim 6, wherein the received information regarding the particular needs of each one of the plurality of students comprises one or more particular needs selected from a group consisting of:
a. a learning style for each one of the plurality of students;
b. competency of each one of the plurality of students on one or more school subjects as determined prior to the first particular time period;
c. particular expressions associated with the student captured while the student was learning information about the one or more school subjects at a time prior to the first particular time period.
d. types of activities best suited to the student's ability to learn the one or more school subjects;
e. test scores from tests taken prior to the first particular time period;
f. the student's understanding of the curriculum;
g. test results from common core standard tests; and
h. results from standardized tests taken prior to the first particular time period.

8. The system of claim 6, wherein the at least one processor is further configured to communicate the pairing of a particular one of the plurality of students with a particular one of the teachers to each one of the plurality of students via a computing device connected to the at least one processor by a communications network.

9. The system of claim 8, wherein the computing device is one or more computing devices selected from a group consisting of:
a. a mobile phone;
b. a tablet;
c. a mobile computing device;
d. a desktop computer and associated display; and
e. a server operatively coupled to a display.

10. The system of claim 6, further comprising an artificial neural network that is used by the at least one processor calculate the pairings.

11. The system of claim 6, wherein information regarding the number of teachers available for the first particular time period is one or more data points selected from a group consisting of:
a. subjects taught by each of the available teachers;
b. teaching styles associated with each of the available teachers;
c. each teacher's enthusiasm about a school subject;
d. each teacher's interpersonal skills;
e. each teacher's adeptness with digital learning tools and technologies; and
f. each teacher's creativity, energy and patience.

12. The system of claim 6, wherein the information received regarding resources available for each one of the plurality of available classrooms is one or more data points selected from a group consisting of:
a. the size of the classroom;
b. the number of seats in the classroom;
c. the number of computers in the classroom;
d. the number of game boards in the classroom;
e. whether collaborative workstations are available in the classroom;
f. whether the classroom has art supplies;
g. whether a classroom is equipped with interactive digital tables;
h. whether a classroom is equipped with one or more interactive whiteboards; and
i. the maximum number of students that may be assigned to the classroom.

13. The system of claim 6, wherein the at least one processor is further configured to:
a. receive information regarding the available teachers for a second particular time period;
b. receive information regarding each one of the plurality of available classrooms for the second particular time period;
c. receive information regarding resources available in each one of the available plurality of classrooms;
d. receive information regarding the particular needs of each one of the plurality of students, as determined from at least the first particular time period;
e. calculate pairings, at least partially based on the available teachers, the resources available for each one of the plurality of classrooms, and the particular needs of each one of the plurality of students, of students, teachers and classrooms that optimize satisfying the particular needs of each one of the plurality students for the second particular time period; and
f. display the pairings between students, teachers and classrooms for the second particular time period prior to the beginning of the second particular time period.

14. The system of claim 13, wherein the first particular time period and the second particular time period occur on the same day.

15. The system of claim 13, wherein the first particular time period and the second particular time period occur on different days.

16. A system for dynamically scheduling participants in a plurality of groupings, the system comprising:
a. at least one processor;
b. memory coupled to the at least one processor; and
c. a display operatively coupled to the at least one processor;
wherein the at least one processor is configured to:
i. receive information regarding the number of available group leaders for a first particular time period;
ii. receive information regarding available resources for the first particular time period;
iii. receive information regarding available activities for the first particular time period;
iv. receive information regarding the needs of each participant;
v. at least partially in response to receiving the number of available group leaders, available resources, available activities and the needs of each participant, calculate a pairing, of a particular group leader, one or more particular participants with a particular resource and a particular activity, based on at least each of the participant's needs so as to optimize satisfying each of the needs of each participant; and
vi. present the pairings on the display.

17. The system of claim 16, wherein the information received regarding the available resources for the first particular time period is one or more data points selected from a group consisting of:
a. the size of the room assigned to the group leader;
b. the number of seats in the room assigned to the group leader;
c. the number of computers in the room assigned to the group leader; and
d. the number of game boards in the room assigned to the group leader.

18. The system of claim 16, wherein the group leader is a teacher and the participants are students.

19. The system of claim 18, wherein the processor is further configured to receive information about a subject matter taught by each teacher.

20. The system of claim 18, wherein the information regarding the needs of each participant further comprises one or more pieces of information selected from a group consisting of:
a. a student's achievement level for each common core standard;
b. a student's understanding of a particular subject matter;
c. a student's learning style; and
d. a student's expressions captured during a prior pairing of a student and teacher.
